(19) United States
(12) Patent Application Publication
(10) Pub. No.: US 2010/0117825 A1
(43) Pub. Date: May 13, 2010

(54) ELECTRONIC DEVICE, INTEGRATED WITH A POSITIONING SYSTEM

(75) Inventor: Roberto Boccacci, Roma (IT)

Correspondence Address: NIXON & VANDERHYE, PC, 901 NORTH GLEBE ROAD, 11TH FLOOR, ARLINGTON, VA, 22203, US

(73) Assignee: ITALDATA INGEGNERIA DELL'IDEA S.P.A., Roma (IT)

(21) Appl. No.: 12/597,055

(22) PCT Filed: Apr. 24, 2008
(86) PCT No.: PCT/EP08/55025

§ 371 Date: Nov. 10, 2009

(30) Foreign Application Priority Data
Apr. 27, 2007 (EP) 07425253.7

(51) Int. Cl. G08B 1/08

(52) U.S. Cl. 340/539.13

(57) ABSTRACT

An electronic device (1) with a positioning system allows an adequate distribution of the electromagnetic waves resulting from the electronic components in an area far away from the operation cone of the GPS antenna which is thereby protected in the best way, and comprises a case (2) in which a closed chamber (20) is defined, housing a satellite antenna (18), formed by walls (21) in shielding material and by a window (22), in non-shielding material, placed at a portion of said case (2), the latter being formed by a first half-shell (24), in shielding material, incorporating said portion wherein the window (22) in non-shielding material is formed, and a second half-shell (25) in non-shielding material, defining in the case (2) a surface opposite to said window (22) in non-shielding material.

The present invention is related to an electronic device, e.g. for the survey and the check of data, integrated with a positioning system.

Device are known performing various functionalities of control and identification of data. However, many kinds of verification exist, requiring the performing of processes different to each other. The adoption of a satellite-based positioning system allows to assign, to each taken datum, a precise geographic reference allocating it at a certain place.

However, especially in the context of the police activities, it is needed to have a compact and easily manageable device, while the available devices have big sizes or, even when they are portable, they has a satellite antenna separated from the body of the electronic device.

The reason for such a separation is due to the sensitivity of the antenna and to the easiness with which the electromagnetic frequencies generated by the usual electronic components may disturb the satellite antenna.

The same problem may be encountered in all the portable electronic device using a satellite positioning system, e.g. the satellite navigators.

This limitation has hence restricts the diffusion of the positioning systems, because the user has to manage two separate members: the device and the antenna, joined together by a wire or by a radio transmission system.

Further, the satellite antenna must have its own power supply and then, being available as separate body, it requires the use of a further wire joining it to a power supply unit.

The technical problem underlying the present invention is to provide a compact electronic device, incorporating a satellite antenna, obviating to the problems cited with reference to the known art.

Such a problem is solved by an electronic device as above specified, comprising a case in which a closed chamber is defined, housing a satellite antenna, formed by walls in shielding material and by a window, in non-shielding material, placed at a portion of said case, the latter being formed by a first half-shell, in shielding material, incorporating said portion wherein the window in non-shielding material is formed, and a second half-shell in non-shielding material, defining in the case a surface opposite to said window in non-shielding material.

The main advantage of the above defined device is to allow an adequate distribution of the electromagnetic waves resulting from the electronic components in an area far away from the operation cone of the GPS antenna which is thereby protected in the best way.

The present invention will be disclosed hereinafter according a preferred embodiment thereof, of an electronic device for the survey of data and for the check of documents, provided with a exemplificative and non-limitative purpose with reference to the annexed drawings wherein:

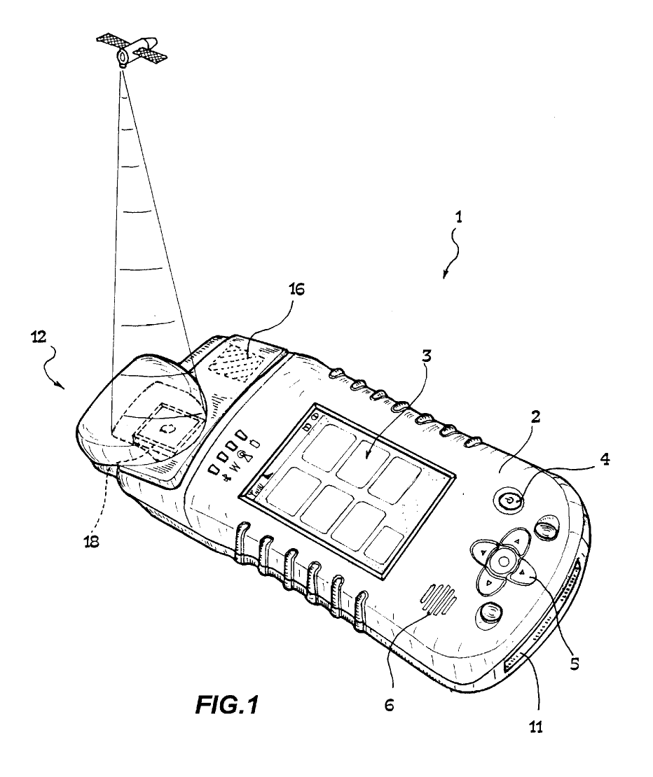

FIG. 1 shows a pictographic perspective view of a device for the survey and the check of identification data, integrated with a communication system, according to the invention, illustrating the functionalities thereof; and

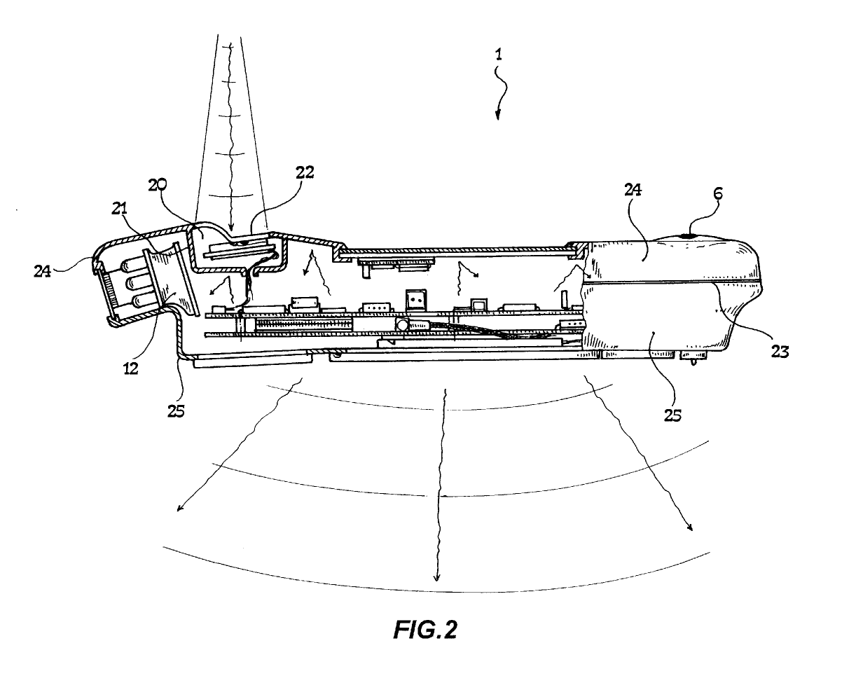

FIG. 2 shows a longitudinal section view of the device of FIG. 1, with an accessory item.

With reference to the figures, a device arranged for the survey, the verification and the transmission of identifying data is globally indicated as 1.

It comprises a solid body 2, made of anti-shock material and completely sealed, suitable for protecting the inside even from weather elements. The surface of the body 2 of the device 1 is anti-slip. It can resist even to impacts and crashes. In particular, the body 2 can be consistent with IP54 standard, i.e. it can operate in presence of dust and water spray and it cannot be penetrated by pointed items.

According the general appearance thereof, the device 1 is a hand-held equipment, suitable to be grasped by one hand and provided with a graphic interface 3 on the front surface thereof, with a display on and off button 4 and with a keyboard 5, as an input and output device.

This kind of device is substantially similar to a wide range of analogous devices like palm computer, cellular phones and so on, which may include the functionality of a satellite positioning system.

In the present embodiment, the device 1 includes sound detection and recording means, and a loudspeaker, represented as a microphone inlet 6 on the body 2 of the device 1. The microphone and the loudspeaker are suitable for the use as telephone.

On the side surfaces, plugs are present for the audio connection, the power supply and a PC connection, e.g. of the USB type. However, it is intended that any data transfer plug can be provided, suitable for the transmission of data in a digital form. The audio connection plug can be preferably connected to earphones of the telephone mentioned above.

At the bottom side surface, the device 1 comprises a slit for the introduction of a card C, and inside the device is provided with a sensor for the microchip reading.

Such a sensor can operate for the verification of documents equipped with microchip, containing the identification data of an individual. This sensor can anyway operate as means for identifying an operator using the device for the survey of evidence or the like.

As a matter of fact, the device 1 can be arranged to operate only after the introduction of an identification document of an operator whose name is mentioned in a list of authorized operators. The device 1 also records the identity of the user for assigning it to the obtained data.

On the opposite side surface, the device 1 comprises means for the taking of images 12 of the digital type, capable of photographic performances and of shooting video. The device 1 further comprises means for the taking of fingerprints, including a scanning surface 16 of the silicon type. The latter, as it is apparent, can operate as means for identifying the operator using the device 1 for the survey of evidence or the like, e.g. by identifying one operator's fingerprint.

The above means generally embodies means for the taking of data of the device 1.

In particular, the operation of the device 1 can be available only after the introduction of a chip card wherein an identifying datum of the operator is recorded, e.g. a fingerprint, and after the verification of such a datum, e.g. through the scanning surface 16. In this manner, the device is not linked to only one operator but the latter must identify himself before using the device. Precautions of the same time may be adopted also for the validation of the collected data. Then, positioning means is provided, namely of the satellite type, comprising an appropriately protected GPS antenna 18.

The device according to the present embodiment comprises cellular communication means. The inner part of the device 1 houses an antenna for the cellular communication, e.g. a GSM antenna, a battery and an encryption card, a memory card and a processor.

Therefore, the device 1 comprises encryption means for sensitive data, e.g. of the type having an asymmetric double key.

It is noted from the given description that the device 1 comprises several electronic components interacting with each other and appropriately connected by buses operating at frequencies which may disturb the antenna 18.

Inside the case 2, a chamber 20 is formed housing the satellite antenna 18. The chamber is formed adjacent to the front surface of the case, where the interface 3 is placed. Such surface is faced upwardly during the normal use of the device 1.

Said chamber 20 is formed by walls 21 realised in shielding material. As shielding material it is intended a material reflecting the electromagnetic waves. Several types of shielding material exist. A suitable material is constituted by a technopolymer loaded with a shielding agent, of the metallic type.

The chamber 20 has a window 22, instead realised with a non-shielding material as a normal anti-shock technopolymer or another material transparent to the electromagnetic waves.

Such a window 22 is placed at a portion of said case 2, i.e. in an area of the front surface of the device, thus also upwardly faced, in an optimal configuration for the interception of satellite signals.

In turn, the case 2 is formed by two half-shells joined at a joint line 23, longitudinal and peripheral.

A first half-shell 24, corresponding at said front surface and incorporating said area on which said window is defined, is realised with the same shielding material as the walls 21 of the chamber 20.

The second half-shell 25, positioned at the back surface of the case 2, is realised with non-shielding material. It is noted that such second half-shell define an opposite surface, in the case 2, with respect to said window 22 in non-shielding material.

In such a way, the electromagnetic waves generated by the electronic components are reflected according to a direction opposite to that of the operation cone of the satellite antenna, thereby preventing any interference.

The positioning references obtained by such a device are therefore precise and are produced rapidly.

In the present embodiment, the collected data by the above mentioned taking means, i.e. image, video or sound recording, fingerprints and so on, and also any other datum collected through any accessory means, or even processing of such data, can be associated to a positioning reference obtained through a satellite positioning system.

The precision of the satellite positioning reference makes such an association particularly suitable for constituting a proof element of the collection of a certain datum in a certain place.

The association with a time-like information, obtainable through means for measuring time like an electronic clock, makes such an association even more absolute. This kind of association can be performed by a software pre-loaded in the same device wherein the satellite antenna 18 is contained.

These pieces of information can be therefore encrypted and transmitted for a subsequent use. Then, the device disclose herein is particularly useful in an employment supporting the police patrolling activities, in the collection of data, in the identity verification, in the survey of testimonies and so on

To the above disclosed electronic device, integrated with a satellite positioning system, a man skilled in the art, to the purpose of achieving further and contingent needing, can introduce additional and several modifications and variants, moreover all of them included within the protection scope of the present invention, as defined by the annexed claims.

1. Electronic device, integrated with a positioning system, comprising a case in which a closed chamber is defined, housing a satellite antenna, formed by walls in shielding material and by a window, in non-shielding material, placed at a portion of said case, the latter being formed by a first half-shell, in shielding material, incorporating said portion wherein the window in non-shielding material is formed, and a second half-shell in non-shielding material, defining in the case a surface opposite to said window in non-shielding material.

2. Device according to claim 1, wherein said shielding material reflects the electromagnetic waves.

3. Device according to claim 2, wherein said shielding material is a technopolymer loaded with a shielding agent.

4. Device according to claim 1, wherein said portion in which the window is formed corresponds to an area of the front surface of the device, upwardly faced during the normal use of the device.

5. Device according to claim 4, wherein, on said front surface, a user's interface is placed.

6. Device according to claim 5, wherein said interface comprises a screen.

7. Device according to claim 1, wherein the two half-shells are joined at a joint line longitudinal and peripheral.

8. Device according to claim 1 comprising means for the taking of data and a software for associating a positioning reference, obtained through said satellite antenna, to said data.

9. Device according to claim 1, comprising means for measuring time, wherein a time reference is added to said association between the collected data and e said positioning reference.

10. Device according to claim 9, comprising means for encrypting said association.
